(19) United States
(12) Patent Application Publication
(10) Pub. No.: US 2008/0130660 A1
(43) Pub. Date: Jun. 5, 2008

(54) SYSTEM AND METHOD OF REAL-TIME CONTROL AND SCHEDULING FOR ZERO-QUEUE DISTRIBUTED SYSTEMS

(76) Inventors: JORDI ROS-GIRALT, Aliso Viejo, CA (US); Wei K. Tsai, Irvine, CA (US)

Correspondence Address: FRANK F. TIAN, 331-4A THIRD AVENUE, LONG BEACH, NJ, 07740, US

(21) Appl. No.: 11/874,756

(22) Filed: Oct. 18, 2007

Related U.S. Application Data
(60) Provisional application No. 60/852,644, filed on Oct. 19, 2006.

(51) Int. Cl. H04L 12/56

(52) U.S. Cl. 370/400

(57) ABSTRACT

A system and method is provided that comprise a logical central controller; and a plurality of logical nodes; wherein a demand is performed such that to transport various commodities from a first set of at least one nodes among the plurality of logical nodes to a second set of at least one node of the plurality of logical nodes is achieved; and wherein said nodes are interconnected by directed links according to a graph, said commodities are allowed to be transported only on said directed links, simultaneous arrival (referred to as collision) of commodities at a node is lost, each transportation of said commodities across a directed link incurs.

### REFERENCE TO RELATED APPLICATIONS

This application claims an invention which was disclosed in Provisional Application No. 60/852,644, filed Oct. 19, 2006 entitled “SYSTEM AND METHOD OF REAL-TIME CONTROL AND SCHEDULING FOR ZERO-QUEUE DISTRIBUTED SYSTEMS”. The benefit under 35 USC § 119(e) of the United States provisional application is hereby claimed, and the aforementioned application is hereby incorporated herein by reference.

### FIELD OF THE INVENTION

The present invention generally relates to a system and method of real-time control and scheduling for zero-queue distributed systems, and more particularly, to a system and method to admit, schedule, and control flows of commodities in real-time to achieve throughput, delay, and other quality of service (QoS) objectives for a distributed system without queues, and more particularly, to multiple-access communications systems with a single broadcast medium.

### BACKGROUND OF THE INVENTION

The background of the present invention relates to a distributed system wherein multiple commodities must be transported from a group of nodes to another group of nodes to meet real-time constraints and objectives, while no queues are allowed at each node. The commodities can be in the form of physical goods or data frames in a digital system. The applicable systems exist in numerous and diverse fields. One applicable example is a just-in-time production system with zero inventory objectives. Another example is an optical communication system without queues. Yet another broad class of examples is multiple-access communications with a single broadcast medium, such as WiFi networks and Ethernet local area networks.

To facilitate the description of the present invention, the class of multiple-access communication systems with a single broadcast medium is assumed to be the applicable systems. This assumption is in no way a restriction on the applicability of the present invention; multiple-access communication systems are only used as a vehicle to describe the present invention in a context, and to avoid verbiage often needed in a general setting.

The objective of the system and method of the present invention in this context is to design an access control and scheduling system to meet QoS requirements for the connections of the communication systems.

In the following description, the multiple-access systems considered are assumed to posses only a single shared medium; therefore no out-of-band coordination or control channels exist. More particularly, the communication medium is assumed to be half-duplex: each node cannot send and receive at the same time.

A prominent characteristic of the multiple-access communication systems considered is that two or more data frames arriving at the same time at a receiver creates a collision and the data frames are considered as lost. This characteristic makes the system equivalent to a distributed system with zero queues at every node in the sense that simultaneous arrivals of two commodities are disallowed.

In the single-medium multiple-access systems considered, multiple nodes can send data frames to a group of intended receivers (while the medium is a broadcast medium and every node is a receiver of all data frames sent over the medium). Since signals propagate to different receivers at different times, it is possible to have collision-free receptions at multiple receivers at the same time. Therefore, while there is only one physical medium, the systems behave as if there are multiple sub-channels.

Two broad classes of access control exist for the systems under consideration: contention-based (often called random access) and scheduled access (sometimes called controlled access). Scheduled access methods come in different forms: examples include token passing, reservation, and etc. Essentially, a controlled access method determines a unique sender at each time to transmit data frames, while the rest of the senders are forbidden to transmit. There exist numerous methods of determining (or arbitrating) the unique sender (or winner in an arbitration). Therefore, these methods can also be considered as arbitration methods. An example of arbitration schemes is the collision avoidance (CA) scheme based on RTS (request-to-send) and CTS (clear-to-send) arbitration.

Examples of contention-based access control include CSMA, CSMA/CA, and CSMA/CD. The problem with these methods is that access to the medium is random, and it is very difficult (if not impossible) to provision guaranteed levels of QoS. This is the main motivation of the current invention.

The two dominant classes of systems to apply the present invention are 802.11x WiFi networks in infrastructure mode and Ethernet networks. In the case of WiFi networks, if random access control is used, when the load is heavy, real-time traffic such as VoIP (voice over IP) will suffer data loss due to collisions. In a random (or contention-based) scheme, a device (often called terminal) can only resume its transmission of data after a random back-off (waiting) time. This back-off time is often larger than the maximum tolerable delay for voice communications, making VoIP over WiFi an unpleasant experience if not impossible for commercial service.

A fundamental problem associated with scheduled access control is that the terminals (potential senders) have unpredictable demands for data transmission. This is a fundamental characteristic of distributed systems. While there exist numerous ways to tackle this problem, the present invention uses a central controller to schedule all QoS transmissions. The reason for such a choice is that, as time goes on, CPU cycles always become more abundant, communication speeds always becomes higher, but propagation delay remain the same. Therefore, a control system that minimizes the penalty of propagation delay will scale up well with the improving technologies.

Another famous issue with multiple-access systems is the hidden terminal problem (HTP). The HTP describes a situation wherein two senders transmit data frames to a common receiver, while each is unaware of the existence of the other sender, and the data frames from both senders collide at the common receiver.

Fundamentally, the access control problem for multiple-access systems is concerning time: when to allow a sender to send. Therefore, scheduling is the fundamental issue and a direct approach to the problem would be to design a schedule control system. In this sense, the HTP is not the most fundamental problem. The more fundamental problem is related to delays between senders and receivers. Theoretically, if the control system ensures that no two data frames will arrive at the same time at the intended receiver, the access control scheme is feasible. Therefore, the delay from a sender to its intended receiver must be taken into account in the design of the control system. The end result of such consideration leads naturally to the approach of the present invention: global scheduling of all QoS transmissions.

Furthermore, the delay from a sender and the central controller can change over time if either or both of them are mobile. This creates a complexity issue in the design of the access control system. The present invention utilizes the principle of feedback control to deal with changes in sender-to-receiver delay.

According to a preferred embodiment of the present invention, in the first phase of the access control system initializes with global clock synchronization, and then it schedules all QoS transmissions in the global clock, with the knowledge of delays between senders and receivers. In the second phase, the system utilizes feedback control to fine-tune the global schedule by adapting to errors in the global clock synchronization, and errors in sender-to-receiver delays.

In the present invention, the control system is subject to errors in the broadcast medium. The access control system is robust in the sense that once the errors disappear, the schedule will be perfect in the next round of the schedule.

According to a preferred embodiment of the present invention, the first part (initialization) of the access control system uses a protocol to synchronize the real-time clocks of the terminal devices in the multiple-access system. Clock synchronization is a well-known problem with a vast body of knowledge in the fields of digital circuit design, real-time systems, operating system, and etc. A standard method of synchronizing clocks for devices that communicate with each other via a network is defined by IEEE 1588 standards. The embodiment of the present invention simply adapts the standard clock synchronization techniques as an initial training phase for the scheduling algorithm.

While there exist numerous time division techniques for scheduling, the present invention is distinguished by its use of time division scheduling at the IP layer. Most, if not all time-division scheduling algorithms for data transmission are designed for link or MAC (media access control) layer.

A common drawback of time-division scheduling is that a time slot can be wasted if it is scheduled for transmission for a terminal that has no data to send. The feature that the wasted time slots are minimal compared to other time division schemes distinguishes the present invention.

### SUMMARY OF THE INVENTION

It is therefore, an objective of the present invention to provide a system and method of control and scheduling to meet QoS requirements for real-time distributed systems with no queue or zero queues.

In the following description of the summary of the invention, single-medium multiple-access communication systems are assumed to be the intended applicable systems. This assumption is in no way a restriction of the general applicability of the present invention.

It is, therefore, an object of the present invention to provide a system and method to provide deterministic QoS guarantees to real-time traffic such as VoIP, IP-HDTV, and so on for bandwidth, delay, delay jitter, and loss.

It is another object of the present invention to provide a system and method to provide probabilistic QoS guarantees to best-effort and non-real-time traffic such as Web browsing, FTP, and other applications.

It is another object of the present invention to provide a system and method to provide an IP-layer time division scheduling for applications that share a single broadcast medium for communications.

It is another object of the present invention to provide a system and method to schedule devices that share a single broadcast medium to transmit data without collisions of data at the receivers, even with hidden terminals among the devices.

It is yet another object of the present invention to provide a system and method to provide QoS guarantees to senders, which are compliant with the QoS control system, without requiring all devices in the communication system to be compliant.

It is still another object of the present invention to provide a system and method to provide scheduling of all transmissions to optimize QoS objectives.

It is yet still another object of the present invention to provide a system and method to provide admission control to optimize QoS objectives.

A system and method comprising: a logical central controller; and a plurality of logical nodes; wherein a demand is performed such that to transport various commodities from a first set of at least one nodes among the plurality of logical nodes to a second set of at least one node of the plurality of logical nodes is achieved.

The nodes are interconnected by directed links according to a graph, said commodities are allowed to be transported only on said directed links, simultaneous arrival (referred to as collision) of commodities at a node is lost, each transportation of said commodities across a directed link incurs.

### BRIEF DESCRIPTION OF THE DRAWINGS

The above and other objects and features in accordance with the present invention will become apparent from the following descriptions of preferred embodiments in conjunction with the accompanying drawings, and in which:

FIG. 1 shows an example of the clock synchronization problem: both nodes have their own internal clock, T(np) and T(nc), and NP must estimate NC's clock within a certain P-confidence level in accordance of the present invention.

FIG. 2 illustrates an example of a 2 P-intervals of confidence for up to 1000 samples and for

### P=0.9, 0.99, 0.999, 0.9999, 0.99999, 0.999999 in accordance of the present invention.

FIG. 3 shows an example of the basic structure of a transmission period TMB stands for time modulation beacon in accordance of the present invention.

FIG. 4 shows an example of the time modulation algorithm: Upon detecting overlapping of terminals T1 and T2, controller commands terminal T2 and terminal T3 to right away postpone their time slots t units of time, where t=D(T1)+D(T2)+g−T in accordance of the present invention.

FIG. 5 shows an example of simple network transmission diagram in accordance of the present invention.

FIG. 6 shows an example of a simplest network transmission diagram with a directed loop in accordance of the present invention.

FIG. 7 shows an example of a typical WiFi infrastructure network transmission diagram in accordance of the present invention.

FIG. 8 shows an example of a feasible ordered transmission diagram without an ordered cycle in accordance of the present invention.

FIG. 9 shows an example of a feasible ordered transmission diagram with an ordered cycle in accordance of the present invention.

FIG. 10 shows an example of a 2-phase QoS scheduling showing collision free phase (QoS) and best-effort phase in accordance of the present invention.

FIG. 11 is an example of a flowchart in accordance of the present invention.

### DETAILED DESCRIPTION OF THE PRESENT INVENTION

Certain embodiments as disclosed herein provide for a MAC module that is configured to be deployed in a wireless communication device to facilitate multi-hop wireless network communications over high bandwidth wireless communication channels based on UWB, OFDM, 802.11/a/b/g, among others. In one embodiment, the nodes involved in the multi-hop wireless communications are arranged in a mesh network topology. For example, one method as disclosed herein allows for the MAC module to determine the network topology by parsing beacon signals received from neighbor nodes within communication range and establish high bandwidth communication links with those nodes that are within range to provide a signal quality that supports high bandwidth communication. For applications that require a certain level of quality of service, the methods herein provide for establishing a multi-hop end-to-end route over the mesh network where each link in the route provides the necessary level of signal quality.

After reading this description it will become apparent to one skilled in the art how to implement the invention in various alternative embodiments and alternative applications. To facilitate a direct explanation of the invention, the present description will focus on an embodiment where communication is carried out over a UWB network, although the invention may be applied in alternative networks including 802.11, 802.15, 802.16, worldwide interoperability for microwave access (“WiMAX”) network, wireless fidelity (“WiFi”) network, wireless cellular network (e.g., wireless wide area network (“WAN”), Piconet, ZigBee, IUP multimedia subsystem (“IMS”), unlicensed module access (“UMA”), generic access network (“GAN”), and/or any other wireless communication network topology or protocol. Additionally, the described embodiment will also focus on a single radio embodiment although multi-radio embodiments and other multiple input multiple output (“MIMO”) embodiments are certainly contemplated by the broad scope of the present invention. Therefore, it should be understood that the embodiment described herein is presented by way of example only, and not limitation. As such, this detailed description should not be construed to limit the scope or breadth of the present invention as set forth in the appended claims.

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In the following description of the invention, single-medium multiple-access communication systems are assumed to be the intended applicable systems. This assumption is in no way a restriction of the general applicability of the present invention.

In the present invention, the key idea is to schedule all transmissions (QoS connections are completely scheduled and transmissions for non-QoS connections are restricted properly) so that there are no collisions at all receivers, thus provisioning QoS guaranteed levels of various kinds.

In the present invention, the basic approach to solve the QoS problem is to elect a central controller and let the central controller schedule all the QoS transmissions in the system, and the scheduling is done with a global clock.

In accordance with a preferred embodiment of the present invention, while the central controller can be attached to any node in the communication system, it is preferred that the central controller is attached to a device that receives data frames from most other nodes in the network. In the case of Ethernet, this implies that the preferred central controller is the access router (the router that connects the Ethernet subnet to the external network). In the case of WiFi network, this implies that the central controller is preferred to be the access point of a WiFi network in the infrastructure mode.

There exist two main challenges facing time-division approaches for access control: data frames could collide at receivers, and data frames could be lost due to impairments (or noise) in the communication medium.

The reasons that packets could collide comprises the following two:
(1) If the scheduling algorithm does not take into account of sender-to-receiver delays, two or more data frames can collide at the intended receivers.
(2) Clocks can change due to drifts in clock frequency, and offsets between clocks are changed due to movements of the devices. If the global clock synchronization contains an error larger than the guard time, then two data frame can collide at receivers (intended or non-intended).

In accordance with a preferred embodiment of the present invention, the problem of imperfect scheduling is solved in two stages. In the first phase, clock synchronization is conducted at every terminal that is QoS-enabled (a terminal is said to be QoS enabled if it runs a QoS software that enables the terminal to actively participate in the QoS process). At the end of the first phase, the central controller receives all the sender-to-receiver (for QoS connections) delays from the receivers, and schedules all the QoS transmissions. In the second phase, the central controller fine-tunes the schedule based on the feedback from the receivers to adapt to errors.

In accordance with a preferred embodiment of the present invention, the central controller does not need to receive any information about the sender-to-receiver delays from the senders to the controller. The fundamental idea of the present invention is that the key in the single medium communication system is that simultaneous arrivals of data cause collisions. The control system is designed to be receiver-driven. This is a very important concept, while there are many factors that may cause collisions, the receiver driven approach let the receiver (the central controller) observe the feedback (collisions and time shifts) and adjust the schedule using the result variables (arrival times) without figuring out the complex cause variables (sender-to-receiver delays and clock synchronization errors).

The purpose of the first phase is that after the first phase, the global schedule must be good enough in the sense that the adaptive (time modulation) algorithm will not be confused but will converge to an optimal schedule in a few rounds. More specifically, the clock synchronization error after phase should be small enough so that two intended transmissions in a sequence do not reverse their order in the physical medium. Such a requirement is easy to meet with a reasonable clock synchronization protocol and reasonable algorithms to estimate sender-to-receiver delays.

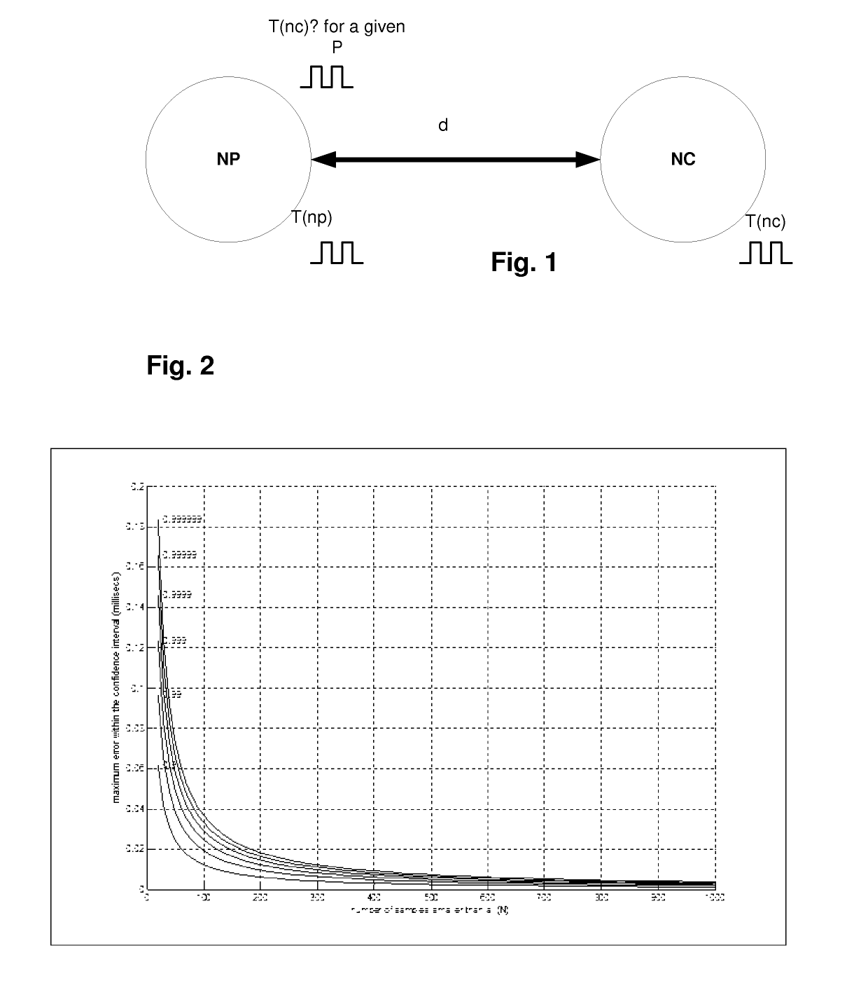

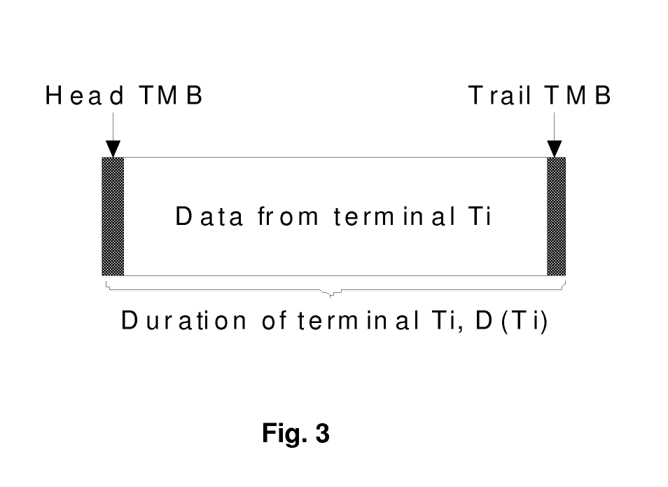

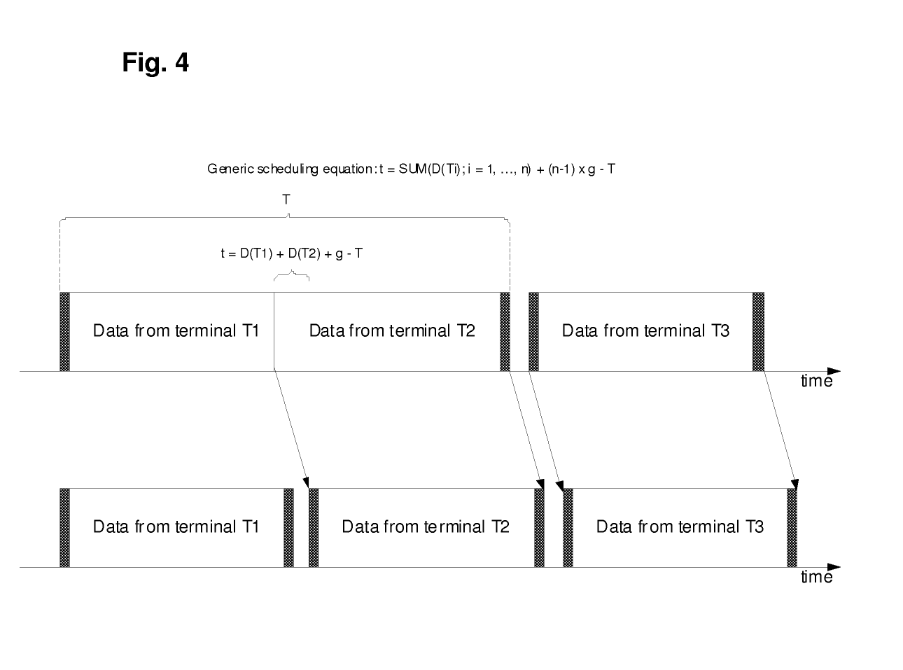

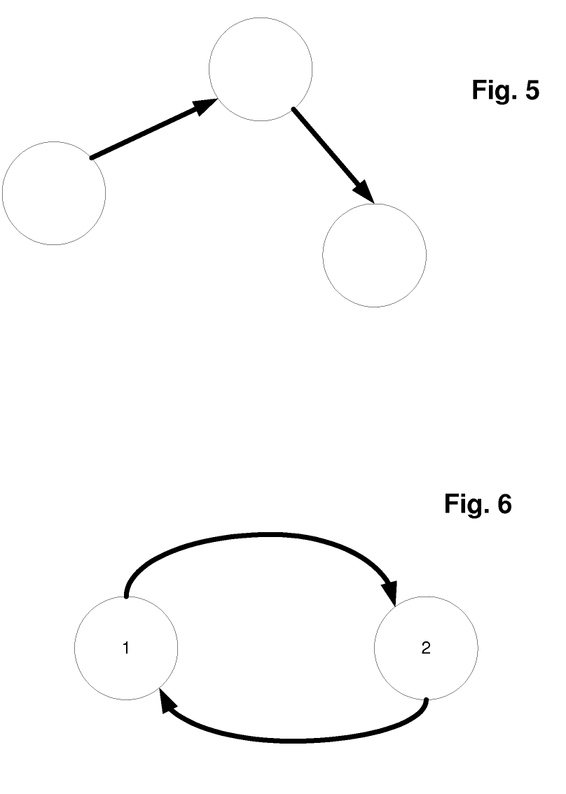

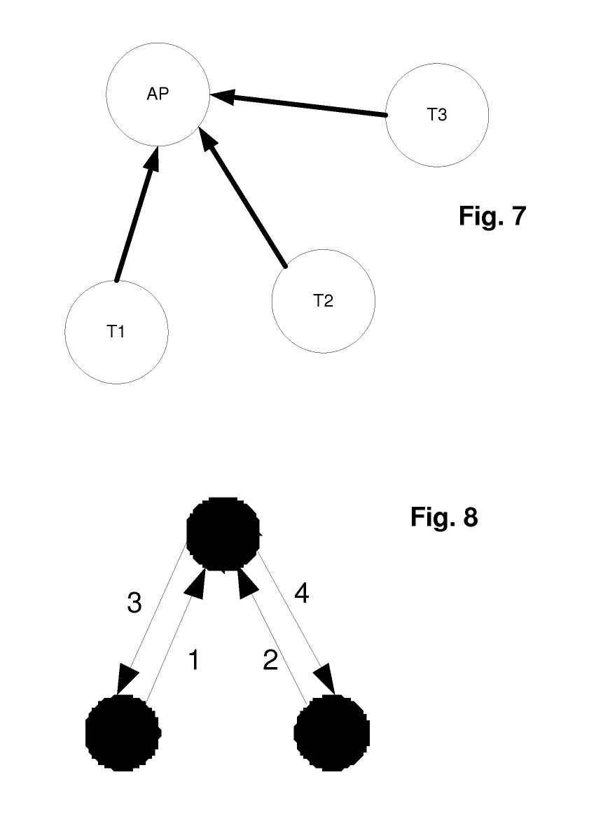

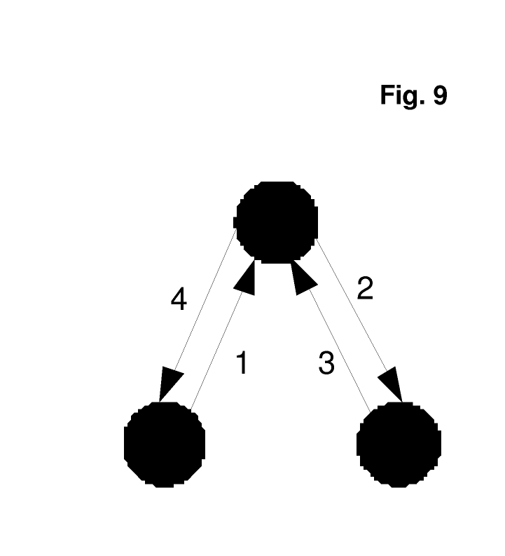

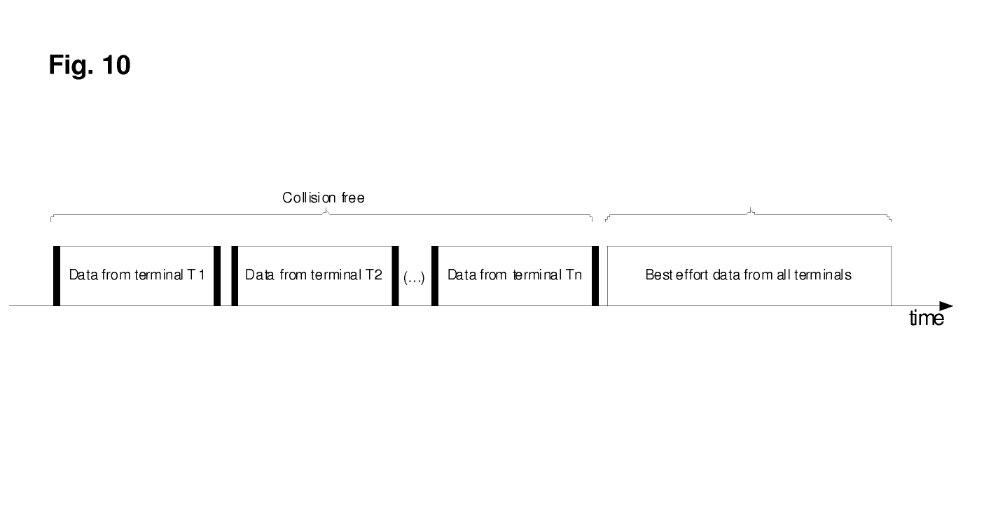

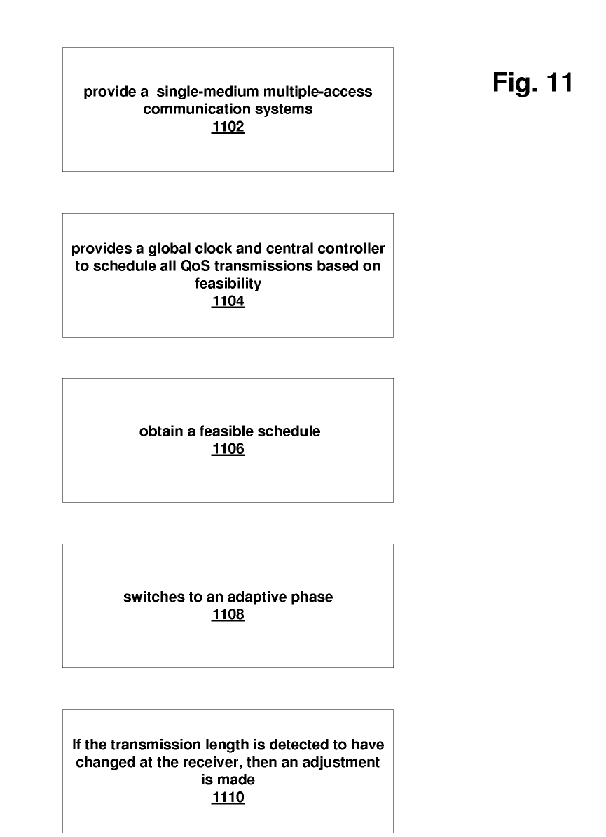

In accordance with a preferred embodiment of the present invention, the clock synchronization scheme used is of the classic type: Cristian's algorithm, commonly used in operating system applications. Let NP and NC be two nodes that can communicate to each other via an arbitrary communication protocol (NP stands for node at the periphery, typically a terminal in the communication system, and NC stands for node at the center, typically the access point). FIG. 1 shows the basic clock synchronization problem.

In accordance with a preferred embodiment of the present invention, NP uses the following method to estimate NC's time: Node NP sends a request message RM to NC and it records the time that it transmits the message. Upon receiving RM, NC sends a reply message to NP, piggybacking on it the current value of its clock T(nc). Upon receiving the reply message, NP estimates NC's clock as follows:

$${{T}^{(} ( nc )}_{i} = {T ( rm )}_{i} + \frac{{RTT}_{i}}{2}$$

where T(rm)ᵢ is the time sample stored in the received message, i.e. the time as indicated by NC's clock at the time the reply was transmitted, and RTT is the difference of the time at which the reply arrives and the time that the request was sent, i.e. the round trip time for the request-reply transaction. The sub-index i is used to indicate a sample.

With N samples, NC estimates NP's current clock time in the following way:

$${T}^{(} ( nc ) = \frac{1}{N} {{å}_{i = 1}}^{N} ( {{T}^{(} ( n c )}_{i} + {D}_{i} )$$

where Δᵢ is the time passed between now and the time that \check{T}(nc)ᵢ was calculated (notice that Δᵢ can be calculated without error by using NP's local clock).

In the case of WiFi networks, NC is an access point while NP corresponds for instance to a mobile terminal MT. Typical RTT values in WiFi networks oscillate around 2 milliseconds. In this synchronization scheme, RTT samples are accepted into the calculation only if it is less than a certain threshold value. Based on a simple and realistic analysis of the error of synchronization, when the number of valid RTT samples is 1000, the interval of confidence is in the order of microseconds. Notice also that in a WiFi network, it is easy to obtain thousands of samples is a few seconds. Hence, the presented method provides a mechanism to synchronize clocks between two network nodes in a few seconds and with a margin of error in the order of a few microseconds.

The root cause for scheduling error is collisions at receivers. There are four possible scenarios to consider: (1) 1 sender to 1 receiver, (2) 1 sender to multiple receivers, (3) multiple senders to 1 receiver, and (4) multiple senders to multiple receivers. It is clear that (1) and (2) do not cause any collisions. Case (3) is the ideal case wherein the present invention is well suited. With only one receiver, the single receiver observes all the collisions on-site, and therefore, the single receiver is the ideal node for the centralized controller to do global scheduling. (There is no need to forward the collisions information to the central controller if the single receiver is the controller.) In the case of WiFi networks in the infrastructure mode, most of the traffic is of the type (2) and (3), and hence the control system with the access point as the central controller is most efficient.

Case (4) is the most difficult and challenging from scheduling point of view. The fundamental issue here is that the existence of multiple receivers “breaks” the single broadcast medium into multiple “channels”: each receiver is a “local channel.” (Since not all transmitted signals propagate to all receivers at the same time, a local channel can be defined from a group of senders to a receiver.) To analyze scheduling for this scenario, a preferred embodiment of the present invention formulates the concept of network transmission diagram to capture the description of traffic patterns.

An example of network transmission diagram is given in FIG. 5. A network transmission diagram is constructed as follows: If there is a transmission demand from node 1 to node 2, then add a directed arc from node 1 to node 2. All nodes that have transmission demands (either on the sending or receiving end) must be included in the diagram.

The network transmission diagram enables the following characteristics of the access control problem: (1) data transmissions can be either streaming or one time; (2) data transmissions can have deadlines or no deadlines; and (3) the resource under contention is the receiver in the sense that only one transmission to the receiver at one time is allowed, (4) data transmission can be lossy, and (5) there is a routing or topology constraint (on what nodes should send to what nodes). These 4 characteristics show the fundamental differences between multiple-access control scheduling and operating system scheduling. It is also important to note that the abstract definition of network transmission diagram conveys the concept of topologically constrained traffic patterns, the access control problem considered by the present invention focuses on real-time scheduling subject to the abstract network transmission diagram.

From a scheduling point of view, there exist three degrees of freedom: (1) begin time of each transmission, (2) duration of each transmission, and (3) guard time inserted before and/or after a transmission. A schedule is said to be feasible if the schedule does not create any collision at all intended receivers for intended data frames. Recall further that a node cannot transmit and receive at the same time. Note that a feasible schedule is collision free by definition.

An ordered transmission diagram is defined as a network transmission diagram with all its directed arcs partially ordered. Each partial order maps to a schedule in the sense that two transmissions must happen in sequence if the corresponding two arcs can be compared in the order. Among all the ordered transmission diagrams, only those that correspond to a feasible schedule are useful.

An ordered transmission diagram that corresponds to a feasible schedule is called a feasible ordered transmission diagram. Further, every feasible ordered transmission diagram corresponds to a group of feasible (hence collision-free) schedule.

An ordered transmission diagram is said to have an ordered cycle if according to the partial order, a sequence of directed arcs form a directed cycle.

In accordance with the present invention, there it can be proved that any feasible ordered transmission diagram without an ordered cycle can be scheduled without a guard time (guard time=0). Thus, for such a schedule having no or zero guard time, when applied to streaming, is a most efficient schedule in the sense that no time was wasted in the communication media.

In accordance with the present invention, it can be proved that if all feasible ordered transmission diagrams contain at least an ordered cycle, then it is impossible to schedule the demanded transmissions with guard time=0. Define the cycle delay associated with a feasible ordered transmission diagram to be the longest delay traversed in an order cycle in the diagram. Among all possible feasible ordered transmission diagrams, one that has the minimal cycle delay is called a minimal ordered transmission diagram. Then any collision free schedule must have a guard time no smaller than the cycle delay of a minimal ordered transmission diagram. Thus, when applied to streaming, a collision-free schedule with a guard time equal to the cycle delay of a minimal ordered transmission diagram is a most efficient schedule in the sense that no time was wasted in the communication media without creating a collision.

FIG. 6 illustrates the simplest case of impossibility of scheduling without a non-zero guard time. Suppose the total delay from node 1 to node 2 and back (round trip time from node 1 to node 1) is d. The schedule {node 1 sending at time=0, 2T, 4T, . . . and node 2 sending at time=1T, 3T, . . . ,} will create collisions at node 1 as long as d is not zero.

FIG. 7 illustrates the network transmission diagram for a typical WiFi network. In this example, it is assumed that all the transmissions are from the terminals (T1, T2, and T3) to the access point (AP). This represents the upload only transmission scenario for this WiFi. According to the theory developed by the present invention, there exists a most efficient schedule with guard time=0. Conversely, if all the arrows in FIG. 7 are reversed, representing the download only scenario, there exists a most efficient schedule with guard time=0.

FIG. 8 shows a feasible ordered transmission diagram without an ordered cycle. It is easy to check that there exists a collision-free schedule with zero guard time for the demanded transmissions. In fact, a simple schedule is one that follows exactly the order of the arcs in the diagram.

FIG. 9 shows a feasible ordered transmission diagram with an ordered cycle. The ordered cycle consists of the ordered arcs: {1,2,3,4}. It is easy to check if one follows the order as a schedule, then to guarantee zero collisions, a guard time equal to the delay traversing the ordered cycle is needed.

In accordance with a preferred embodiment of the present invention, the second phase of the access control is done by an adaptive process called time modulation. In the time modulation algorithm, a feasible schedule was initially given. However, due to clock synchronization errors, measurement errors, collisions may still occur. When collisions occur, two or more separate transmissions must have overlapped in their common receiver channel. This can be detected by measuring the length of the received data frames. If a transmission changes its length at the receiver, then a collision has occurs. In order to determine the length of a transmission session, it is necessary to know the begin time and end time of the transmission session.

In accordance with a preferred embodiment of the present invention, beacons mark the beginning and the ending of a transmission session. These beacons are called head TMB (time modulation beacon) and tail TMB. FIG. 3 illustrates a typical transmission session, with its length, and the head and the tail TMBs.

In accordance with a preferred embodiment of the present invention, the TMB beacons are special beacons that contain a heavy-duty error-correction code so that it is practically impossible to lose these beacons in the channel due to noise. Thus, unless a disaster happens, if a TMB disappears, it must have collided with other data frames.

In accordance with a preferred embodiment of the present invention, it is easy to verify that noise does not cause changes in the lengths of transmission sessions. Therefore, if the length of a transmission changes, it must be caused by a collision.

In accordance with a preferred embodiment of the present invention, the time modulation algorithm corrects a collision by adjusting the transmission times in the next cycle (round) so that in the next scheduled transmission, the two collided sessions do not overlap again. This is illustrated in FIG. 4, wherein g represents the guard time. This process of adjustment in time is similar to a phase-locked loop wherein minor errors in the phase are corrected by a feedback process.

In accordance with a preferred embodiment of the present invention, the adjustment increments (shifts in begin and end times) in the time modulation algorithm can be a small constant (in the order of smallest time slots of the global clock) or calculated according to a convergent adaptive algorithm.

In accordance with a preferred embodiment of the present invention, there exist non-QoS compliant nodes within the multiple-access system. The single medium is accessed in cycles wherein each cycle contains 2 phases. In the first phase, only the QoS compliant nodes are allowed to send and receive, and their transmissions are scheduled to be collision free and most efficient (in the sense that the guard time is minimized). In the second phase, the non-QoS compliant nodes are allowed to send and receive data frames.

In accordance with a preferred embodiment of the present invention, if in a schedule, a scheduled QoS compliant node does not use up the entire time slot, all the QoS compliant nodes in the current round of the schedule, following the node that does not use up the allotted time, are allowed to start transmissions by a constant period of time.

In accordance with a preferred embodiment of the present invention, in the WiFi networks, phase 1 and phase 2 of each cycle are reserved by the RTS-CTS handshakes.

In accordance with a preferred embodiment of the present invention, the scheduling is done at the IP-layer. Further, a QoS connection is identified by the transport layer header (containing the IP addresses and port numbers of the senders and receivers, and the protocol number). For example, if a connection is detected to be a VoIP connection, then all its transmissions (send and receive) requests are automatically considered to be of QoS type.

In accordance with a preferred embodiment of the present invention, there exists a separate QoS admission server that keeps track of live QoS connections. This QoS admission server is a logical device is preferred to be coincide with the central controller, but it can reside within any node in the communication system. Whenever, a connection (without being admitted first) is detected to be of QoS type, the connection (identified by the logical sending node) is automatically considered by the QoS server for admission. A QoS connection can also request its QoS admission by sending a special admission request to the QoS admission server.

In accordance with a preferred embodiment of the present invention, the QoS admission calculates the system status (the number of QoS sessions, the guard times, error rates, throughput, delay, and other QoS parameters) to administer rejection and admission of QoS nodes to maintain the communication system under its desired operating conditions. If a QoS node becomes inactive over a certain threshold of time, it will be removed from the QoS admitted list.

Referring to FIG. 11, there is provided a system and method of real-time control and scheduling for distributed system with zero queues. While the system and method is applicable to diverse and numerous systems, the vehicle used to describe the invention is to provide a single-medium multiple-access communication systems (Step 1102), wherein the main objectives for control is to enable QoS of connections inside the systems. The QoS control system provides a global clock and central controller to schedule all QoS transmissions based on feasibility, sender-to-receiver delays, and the global clock (Step 1104). Once a feasible schedule has been obtained (Step 1106), the system switches to an adaptive phase (Step 1108), wherein errors in scheduling are detected (using a scheme called time modulation) and corrected. In the time modulation algorithm, beacons with heavy-duty error correction codes are inserted at the beginning and the end of a transmission session. If the transmission length is detected to have changed at the receiver, then an adjustment is made (Step 1110). The system and method also provide a means to determine feasibility of a schedule. Hints are given to produce most efficient schedule in the sense that the needed guard time is minimized.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system comprising:
a logical central controller; and
a plurality of logical nodes;
wherein a demand is performed such that to transport various commodities from a first set of at least one nodes among the plurality of logical nodes to a second set of at least one node of the plurality of logical nodes is achieved; and
wherein said nodes are interconnected by directed links according to a graph, said commodities are allowed to be transported only on said directed links, simultaneous arrival (referred to as collision) of commodities at a node is lost, each transportation of said commodities across a directed link incurs a penalty of delay, and each commodity is transported via a fixed and unique path.

2. The system of claim 1 wherein nodes are of two types: QoS type and non-QoS type, and the QoS type nodes must satisfy a plurality of real-time quality of service (QoS) measures, and the purpose of the system (called control system) is to exercise control to achieve system wide real-time QoS objectives.

3. The system of claim 2 wherein the commodities are data frames in a digital system.

4. The system of claim 3 wherein the control system schedules the sending of all data frames via a global clock realized with a global clock synchronization method.

5. The system of claim 4 wherein the control system schedules the sending of all data frames via a time division multiplexing method at the IP layer.

6. The system of claim 5 wherein the central controller uses sender-to-receiver delays, QoS type information, and QoS requirements to determine the schedule to allow real-time transmitting of data frames from QoS nodes, and real-time limiting of data frame transmissions from non-QoS nodes.

7. The system of claim 6 wherein the control system uses an adaptive algorithm to adjust begin times, end times, and guard times of all transmissions of QoS type to avoid collisions and achieve certain real-time QoS objectives, based on feedback from a plurality of receivers of data frames.

8. The system of claim 7 wherein the network of nodes forms a WiFi network or a network of Ethernet local area networks.

9. The system of claim 8 wherein a space-time trace of a schedule is formed by following the scheduled transmissions sequentially over time and connecting the directed links traversed sequentially.

10. The system of claim 9 wherein the control system chooses a schedule only if the corresponding space-time trace does not form a directed cycle.

11. The system of claim 10 wherein all feasible space-time traces contain a directed cycle, the control system chooses a guard time equal to the total delay in a directed cycle that exists in a space-time trace, and in particular, the system chooses the minimum delay traversed in the said directed cycles.

12. The system of claim 11 wherein the control system includes a QoS admission server to administer rejection and admission of live QoS nodes.

13. The system of claim 12 wherein an objective of the QoS admission server is to ensure feasibility of finding a schedule to satisfy the real-time QoS objectives.

14. The system of claim 13 wherein if a time slot is allotted to a QoS node but the node does not use up the allotted time, then all the QoS nodes in the current round in the schedule, following the node that does not use up the allotted time, are allowed to begin transmissions earlier by a constant or predetermined time period.

15. The system of claim 14 wherein the control system uses a two-phase approach, wherein the first phase uses global clock synchronization to establish a reference schedule, and the second phase uses incremental adjustments to fine-tune the schedule in an adaptive and convergent algorithm.

16. The system of claim 8 wherein each QoS transmission is preceded immediately by a special (called head) beacon and followed immediately by a special (called trail) beacon.

17. The system of claim 16 wherein the special head and trail beacons contain enough error correction coding to ensure proper receptions even at high noise at the intended receivers, assuming no collisions at the respective receivers.

18. The system of claim 17 wherein the positions of the special head and trail beacons are used as feedback to the adaptive algorithm to adjust the transmission schedule for the next round.

19. A method comprising the steps of:
providing a logical central controller;
providing a plurality of logical nodes; and
demanding to transport various commodities from a first set of at least one nodes among the plurality of logical nodes to a second set of at least one node of the plurality of logical nodes;
wherein said nodes are interconnected by directed links according to a graph, said commodities are allowed to be transported only on said directed links, simultaneous arrival (referred to as collision) of commodities at a node is lost, each transportation of said commodities across a directed link incurs a penalty of delay, and each commodity is transported via a fixed and unique path.

20. The method of claim 19, wherein nodes are of two types: QoS type and non-QoS type, and the QoS type nodes must satisfy a plurality of real-time quality of service (QoS) measures, and the purpose of the system and method (called control system) is to exercise control to achieve system wide real-time QoS objectives.
